(19) United States
(12) Patent Application Publication
(10) Pub. No.: US 2021/0352188 A1
(43) Pub. Date: Nov. 11, 2021

(54) MEDIA SCANNING ASSEMBLIES

(71) Applicant: Hewlett-Packard Development Company, L.P., Spring, TX (US)

(72) Inventors: Ryan M. Smith, San Diego, CA (US); Rene Octavio Valenzuela-Rivas, San Diego, CA (US); Craig T. Johnson, San Diego, CA (US)

(73) Assignee: Hewlett-Packard Development Company, L.P., Spring, TX (US)

(21) Appl. No.: 17/256,748

(22) PCT Filed: Jan. 31, 2019
(86) PCT No.: PCT/US2019/016069

§ 371 Date: Dec. 29, 2020

(51) Int. Cl. H04N 1/12; H04N 1/10; B65H 1/04

(52) U.S. Cl. CPC H04N 1/1245; H04N 1/1215; B65H 2801/39; B65H 1/04; B65H 2801/15; H04N 1/1065

(57) ABSTRACT

Example media scanning assemblies are disclosed. In an example, the media scanning assembly includes a media feeder assembly including an output tray, an input tray disposed vertically lower than the output tray, and a first scanning device. In addition, the media scanning assembly includes a flatbed scanning assembly coupled to the media scanning assembly. The flatbed scanning assembly includes a transparent platen and a second scanning device to move relative to the platen. The media feeder assembly includes a media path extending from the input tray, across a portion of the platen, to the output tray, and the media feeder assembly is to advance media along the media path from the input tray to the output tray so that the first scanning device is to scan a first side of the media and the second scanning device is to scan a second side of the media through the platen.

### BACKGROUND

Scanning devices are typically used to convert physical documents or photographs (generally referred to herein as “media”) into a digital format, such as, for example, a digital file. Once converted, the digital file may be more easily stored and shared via electronic devices (e.g., computers, servers, smartphones, tablets, etc.).

### BRIEF DESCRIPTION OF THE DRAWINGS

Various examples will be described below referring to the following figures:

FIG. 1 is a perspective view of a media scanning assembly according to some examples;

FIG. 2 is a schematic side view of the media scanning assembly of FIG. 1 according to some examples;

FIG. 3 is another schematic side view of the media scanning assembly of FIG. 1 with an upper housing rotated relative to a lower housing according to some examples; and

FIG. 4 is a side view of a printing and scanning device including the media scanning assembly of FIG. 1 according to some examples.

### DETAILED DESCRIPTION

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the following discussion and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections. In addition, as used herein, the terms “axial” and “axially” generally mean along or parallel to a given axis (e.g., central axis of a body or a port), while the terms “radial” and “radially” generally mean perpendicular to the given axis. For instance, an axial distance refers to a distance measured along or parallel to the axis, and a radial distance means a distance measured perpendicular to the axis.

As used herein, including in the claims, the word “or” is used in an inclusive manner. For example, “A or B” means any of the following: “A” alone, “B” alone, or both “A” and “B.” In addition, when used herein (including the claims) the words “generally,” “about,” “approximately,” or “substantially” mean within a range of plus or minus 20% of the stated value.

As used herein, the terms “downstream” and “upstream” are used to refer to the arrangement of components and features within a device with respect to the “flow” of media through the device during operations. Thus, if a first component of a device receives media after it is output from a component of the device during operations, then the first component may be said to be “downstream” of the second component and the second component may be said to be “upstream” of the first component.

As previously described, scanning devices are typically used to digitize some types of media. In some circumstances, scanning devices may include an automatic media feeder assembly that is to draw media from an input tray, traverse the media past a scanning device, and then dispense the media into an output tray. The additional components of the automatic media feeder assembly tend to increase the overall size of the scanning device. In some circumstances, the increased size of the scanning device may result in an increase in costs (e.g., costs for transportation, storage, construction, etc.). Therefore, one may wish to minimize the size of such scanning devices. Accordingly, examples disclosed herein include media scanning assemblies having a specified arrangement and collection of components such that the dimensions (or some of the dimensions) of the scanning assembly may be reduced, while still preserving (and potentially even enhancing) the functionality of the scanning device for users.

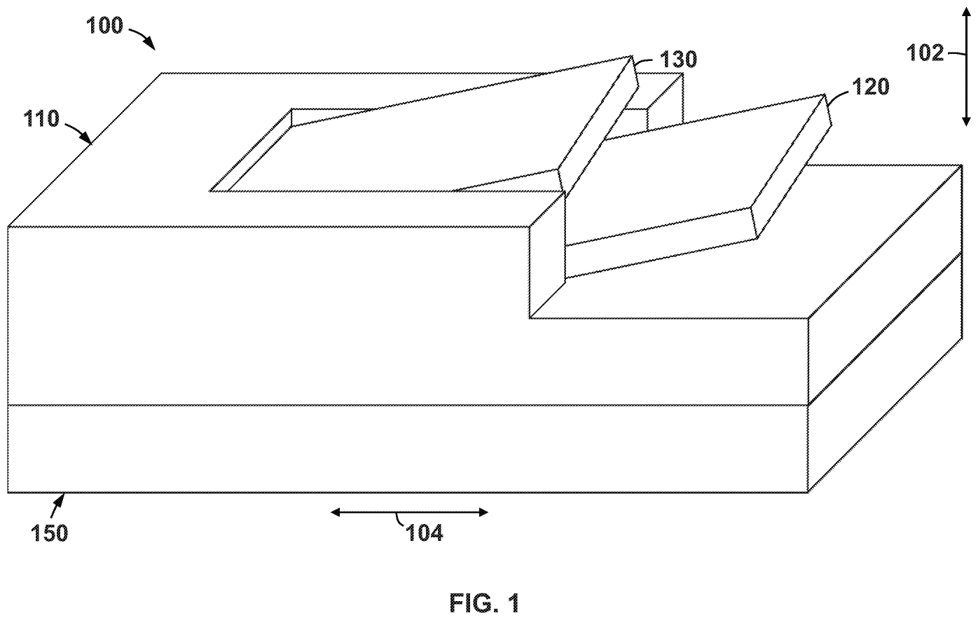

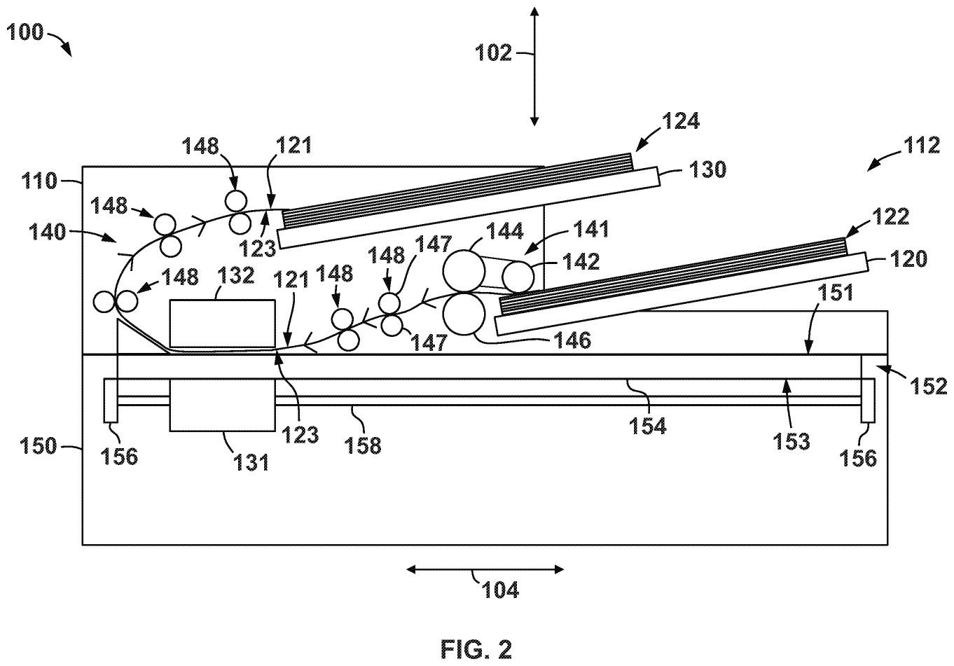

Referring now to FIG. 1, a media scanning assembly 100 according to some examples is shown. Generally speaking, media scanning assembly 100 may include a first or upper housing 110, and a second or lower housing 150 coupled to upper housing 110. Upper housing 110 supports an input tray 120 and an output tray 130. In particular, as shown in FIG. 1, input tray 120 is disposed vertically lower than output tray 130 with respect to the vertical direction 102. In addition, in this example, output tray 130 is laterally shifted relative to input tray 120 along the lateral direction 104 such that output tray 130 is disposed over a portion of input tray 120. In particular, in this example, output tray 130 is laterally shifted relative to input tray 120 along lateral direction 104 so that a majority (more than 50%) of input tray 120, such as, for example, a majority of the surface area of input tray 120, is exposed as viewed in the vertical direction 102 (see also FIG. 2). In other examples, output tray 130 may be further shifted relative to input tray 120 in the lateral direction 104 so that output tray 130 may not extend over any portion of input tray 120, and input tray 120 is fully or totally exposed as viewed in the vertical direction 102. In addition, in still other examples, output tray 130 may not be laterally shifted relative to input tray 120 such that output tray 130 is disposed over the entirety of input tray 120. As will be described in more detail below, media scanning assembly 100 is to automatically draw media disposed on the input tray 120 into and along a media path that extends over a plurality of scanning devices (not shown in FIG. 1), and then dispense the media onto output tray 130.

Referring now to FIG. 2, media scanning assembly 100 generally includes a flatbed scanning assembly 152 and a media feeder assembly 112. Flatbed scanning assembly 152 is supported by lower housing 150, while media feeder assembly 112 is supported by upper housing 110. As will be described in more detail below, media feeder assembly 112 includes a first or upper scanning device 132 to scan a first side of media, and flatbed scanning assembly 152 includes a second or lower scanning device 131 to scan a second side of the media.

Flatbed scanning assembly 152 includes a platen 154, and lower scanning device 131 that is movably coupled within lower housing 150. Platen 154 may include a first or upper surface 151 and a second or lower surface 153. Platen 154 may be transparent such that light may freely pass through surfaces 151, 153 during operations. In this example, platen 154 is a pane of transparent glass; however, other types of transparent materials are contemplated. Platen 154 is mounted within lower housing 150 such that upper surface 151 forms a part (or all of) an upper surface of lower housing 150.

Lower scanning device 131 may be referred to herein as a flatbed scanning device and is therefore disposed within lower housing 150, generally below platen 154. Lower scanning device 131 may comprise any suitable device or collection of devices that are to scan a surface or side of media during operations. For example, lower scanning device 131 may include a camera or collection of cameras that capture an image of a side of media. In this example, lower scanning device 131 is to move relative to platen 154 during certain scanning operations (e.g., such as flatbed scanning that does not utilize the media feeder assembly 112). In particular, in this example, lower scanning device 131 is mounted to a rail 158 that extends between a pair of blocks 156 within lower housing 150. During operations, lower scanning device 131 is movable along rail 158 in the lateral direction 104 relative to platen 154. Any suitable driver or driver assembly may be used to move lower scanning device 131 along lower surface 153 of platen 154, such as, for example, an electric motor (which is not shown in FIG. 2 so as to simplify the figure).

Referring still to FIG. 2, media feeder assembly 112 is generally supported by upper housing 110 and includes input tray 120, output tray 130, as well as a media path 140 and upper scanning device 132. Upper scanning device 132 may be similar to lower scanning device 131, and thus, the general description above with respect to lower scanning device 131 may be applied to describe upper scanning device 132 as well. However, in this example, upper scanning device 132 is fixably mounted within upper housing 110. As a result, during operations, upper scanning device 132 does not move relative to upper housing 110.

Media path 140 includes a plurality of roller pinches 148 disposed along the media path 140 within upper housing 110 to engage with and advance media therealong during operations. Each roller pinch 148 includes a pair of rollers 147 that are rotated during operations to pinch a piece of media therebetween. In addition, media path 140 includes a feed roller assembly 141 that is disposed within upper housing 110, proximate input tray 120. Feed roller assembly 141 includes a pick roller 142, a first feed roller 144 and a second feed roller 146. It should be appreciated that the location, number, and arrangement of roller pinches 148 and/or feed roller assembly 141 may be varied in other examples, and that the depicted arrangement of these components in FIG. 2 is merely one implementation that may be used.

During operations, pick roller 142 is rotated to advance a piece of media from a stack 122 disposed within input tray 120. Specifically, the media is drawn from stack 122 by pick roller 142 toward first and second feed rollers 144 and 146, respectively. The media is then advanced through media path 140 via the roller pinches 148.

As shown in FIG. 2, media path 140 extends past the lower scanning device 131 and the upper scanning device 132. In particular, once media is drawn into media path 140 via feed roller assembly 141 as previously described, the media is then drawn or advanced across a portion of upper surface 151 of platen 154 and past the upper scanning device 132 and lower scanning device 131. During this process, upper scanning device 132 is to scan a first side 121 of the media, while lower scanning device 131 is to scan a second, opposite side 123 of the media. In addition, lower scanning device 131 is to scan the second side 121 of the media through transparent platen 154 (e.g., across lower surface 153 and upper surface 151).

In this example, media is placed within input tray 120 such that the first side 121 of the media within stack 122 faces generally upward or away from input tray 120 and second side 123 of the media within stack 122 faces generally downward or toward input tray 120. In addition, in this example, the first side 121 of the media may be the front side of the media, while the second side 123 may be the back side of the media. Thus, in this example, as the media is advanced from input tray 120 and past lower scanning device 131 and upper scanning device 132, the first side 121 faces generally vertically upward, while the second side 123 faces generally vertically downward, with respect to the vertical direction 102.

Referring still to FIG. 2, once the media is advanced past upper scanning device 132 and lower scanning device 131 such that first and second sides 121, 123 are scanned, respectively, as previously described above, the media path 140 flips the media so that the first side 121 faces generally vertically downward and the second side 123 faces generally vertically upward. To facilitate this flipping of the media, media path 140 is generally c-shaped between input tray 120 and output tray 130. Thereafter, the media path 140 dispenses the now scanned and flipped media into output tray 130 such that a stack 124 is formed therein. The media is arranged within output tray 130 such that the first side 121 of the media within stack 124 faces toward output tray 130 and second side 123 of the media within stack 124 faces away from output tray 130.

Thus, media scanning assembly 100 is to automatically draw media into media path 140 from input tray 120, scan both sides (e.g., first and second sides 121 and 123, respectively) and dispense the scanned media into output tray 130. Because input tray 120 is disposed vertically lower than output tray 130 as previously described, many of the components of media path 140 (e.g., feed roller assembly 141, roller pinches 148, etc.) may be disposed relatively low and thus close to platen 154 of flatbed scanning assembly 152, and output tray 130 may be generally offset from input tray 120 in the lateral direction 104 as previously described. Accordingly, the vertical height difference between output tray 130 and input tray 120 may be significantly reduced, and the overall vertical height of media scanning assembly 100 may be minimized. In addition, by placing the output tray 130 above the input tray 120 within media scanning assembly 100, a user may more easily access and retrieve scanned media from output tray 130 following a scanning operation as described above (e.g., stack 124). Further, in examples where output tray 130 is shifted relative to input tray 120 in the lateral direction 104 so that a majority of input tray 120 is exposed as viewed in the vertical direction 102 as described above (see e.g., FIGS. 1 and 2), a user may also more easily access input tray 120 during a scanning operation.

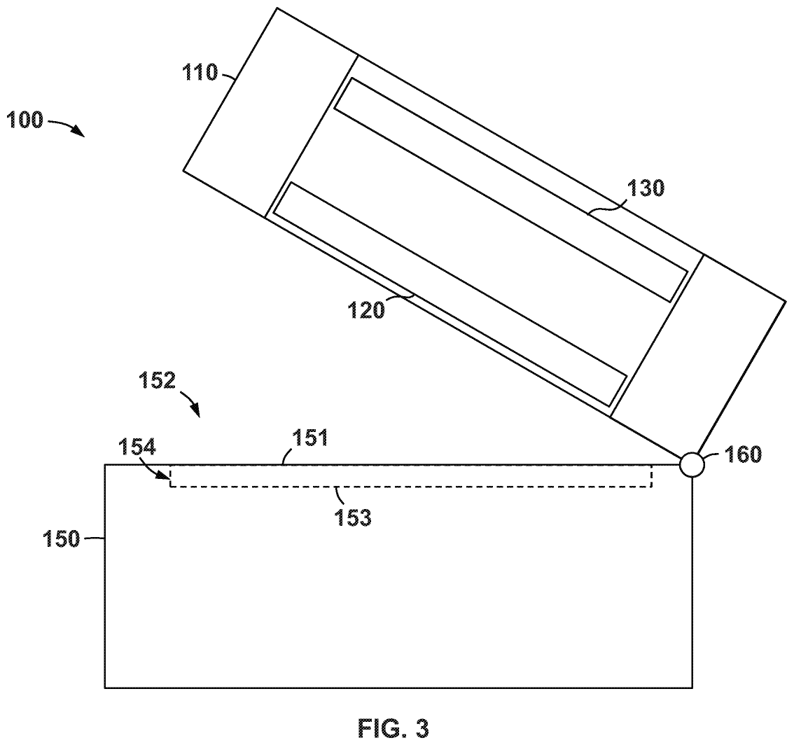

Referring now to FIG. 3, in some examples upper housing 110 is pivotably coupled to lower housing 150 so as to selectively expose platen 154 of flatbed scanning assembly 152. In particular, upper housing 110 is coupled to lower housing 150 with a hinge 160 or other suitable mechanism. During operations, a user may rotate upper housing 110 relative to lower housing 150 about hinge 160 so as to expose transparent platen 154 (specifically upper surface 151 of platen 154).

Referring now to FIGS. 2 and 3, in some circumstances, a user may wish to scan a piece of media without utilizing media feeder assembly 112. Accordingly, the user may rotate upper housing 110 about hinge 160 relative to lower housing 150 so as to expose platen 154 as previously described above (see e.g., FIG. 3). Thereafter, the user may place the piece of media directly on upper surface 151 of platen 154 (upper surface 151 and/or lower surface 153 may have alignment features or graphics to assist user in properly placing and aligning the media on the upper surface 151). Once placed on upper surface 151, upper housing 110 may be rotated about hinge 160 to enclose or capture the media on upper surface 151. Thereafter, lower scanning device 131 may be actuated to scan the downward facing side of the placed media through the transparent platen 154 (i.e., across surfaces 151, 153). During this process, because the media is fixed in position along upper surface 151 of platen 154, lower scanning device 131 may traverse along rail 158 in the lateral direction 104 as previously described above in order to scan the entire lower side of the media. Upon completion of the scanning operation, the user may once again rotate upper housing 110 about hinge 160 to expose platen 154 and retrieve the media from upper surface 151.

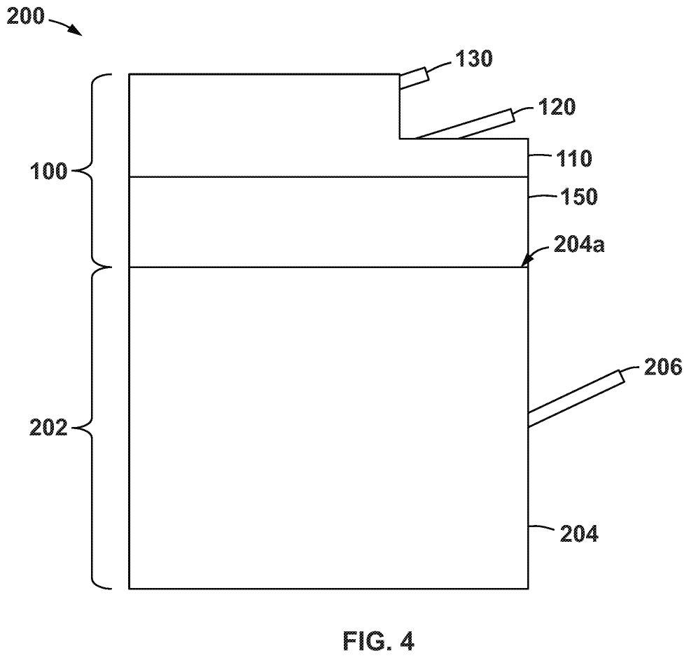

Referring now to FIG. 4, a printing and scanning device 200 according to some examples disclosed herein is shown. Printing and scanning device 200 includes the media scanning assembly 100 as previously described and a printing assembly 202 coupled to media scanning assembly 100.

Printing assembly 202 may comprise any suitable device for placing or affixing an image onto a piece of media. For example, printing assembly 202 may comprise an inkjet printer, a laser printer, etc. In this example, printing assembly 202 includes a printing assembly housing 204 and an output tray 206 for receiving media following a printing operation.

In this example, lower housing 150 of media scanning assembly 100 is fixably coupled to printing assembly housing 204. In particular, lower housing 150 is mounted to a top side 204a of printing assembly housing 204. In other examples, lower housing 150 and print assembly housing 204 may be integrated into a single housing.

During operations, a user may utilize printing and scanning device 200 to scan a piece of media or multiple pieces of media via media scanning assembly 100 as previously described above. In addition, a user may utilize printing and scanning device 200 to print images upon pieces of media (e.g., print media) via the printing assembly 202. Thus, printing and scanning device 200 may be referred to herein as an all-in-one printing and scanning device 200.

In the manner described, a media scanning assembly having a reduced vertical height (e.g., media scanning assembly 100) may be utilized to scan pieces of physical media. As a result, the media scanning assembly may occupy a reduced volume, carry reduced costs, and may be more easily incorporated into other devices (e.g., printing and scanning device 200). In addition, because the output tray (e.g., tray 130) is placed above the input tray (e.g., input tray 120) within examples of the media scanning assembly described herein (e.g., media scanning assembly 100), a user may more easily access and retrieve scanned media from output tray following a scanning operation as described above.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A media scanning assembly comprising:
a media feeder assembly comprising:
an output tray;
an input tray disposed vertically lower than the output tray; and
a first scanning device; and
a flatbed scanning assembly coupled to the media feeder assembly, the flatbed scanning assembly comprising:
a transparent platen; and
a second scanning device to move relative to the platen;
wherein the media feeder assembly comprises a media path that extends from the input tray, across a portion of the platen, to the output tray; and
wherein the media feeder assembly is to advance media along the media path from the input tray to the output tray so that the first scanning device is to scan a first side of the media and the second scanning device is to scan a second side of the media through the platen.

2. The media scanning assembly of claim 1, comprising a first housing pivotably coupled to a second housing, wherein the media feeder assembly is supported by the first housing, and wherein the flatbed scanning assembly is supported by the second housing.

3. The media scanning assembly of claim 2, wherein the first housing is rotatable relative to the second housing to expose the platen of the flatbed scanning assembly.

4. The media scanning assembly of claim 3, wherein the first scanning device is disposed within the first housing.

5. The media scanning assembly of claim 4, wherein the media path is to flip to the media between the input tray and the output tray.

6. The media scanning assembly of claim 5, wherein the output tray is offset from the input tray in a lateral direction so that a majority of the input tray is exposed as viewed in a vertical direction.

7. A printing and scanning device, comprising:
a printing assembly to print images on pieces of print media; and
a media scanning assembly coupled to the printing assembly, wherein the media scanning assembly comprises:
a media feeder assembly comprising:
an output tray;
an input tray disposed vertically lower than the output tray; and
a first scanning device; and
a flatbed scanning assembly coupled to the media feeder assembly, the flatbed scanning assembly comprising:
a transparent platen; and
a second scanning device to move relative to the platen;
wherein the media feeder assembly comprises a media path that extends from the input tray, across a portion of the platen, to the output tray; and
wherein the media feeder assembly is to advance media along the media path from the input tray to the output tray so that the first scanning device is to scan a first side of the media and the second scanning device is to scan a second side of the media through the platen.

8. The printing and scanning device of claim 7, wherein the media scanning assembly comprises a first housing pivotably coupled to a second housing, wherein the media feeder assembly is supported by the first housing, and wherein the flatbed scanning assembly is supported by the second housing.

9. The printing and scanning device of claim 8, wherein the printing assembly comprises a printing assembly housing, and wherein the second housing is fixably coupled to the printing assembly housing.

10. The printing and scanning device of claim 9, wherein the first housing is rotatable relative to the second housing to expose the platen of the flatbed scanning assembly.

11. The printing and scanning device of claim 10, wherein the first scanning device is disposed within the first housing.

12. The printing and scanning device of claim 11, wherein the media path is to flip to the media between the input tray and the output tray.

13. The printing and scanning device of claim 12, wherein the transparent platen comprises a pane of glass.

14. A media scanning assembly comprising:
a flatbed scanning assembly comprising a transparent platen and a lower scanning device to move relative to the platen; and
a media feeder assembly coupled to the flatbed scanning assembly, wherein the media feeder assembly comprises:
an output tray;
an input tray disposed vertically lower than the output tray;
a media path extending from the input tray, across a portion of the platen, to the output tray; and
an upper scanning device;
wherein the media feeder assembly is to advance media along the media path from the input tray to the output tray so that the upper scanning device is to scan a first side of the media and the lower scanning device is to scan a second side of the media through the platen; and
wherein the media path is to flip the media between the input tray and the output tray.

15. The media scanning assembly of claim 14, wherein the media path and upper scanning device are disposed within an upper housing, wherein the platen and lower scanning device are disposed within a lower housing, and wherein the upper housing is rotatable relative to the lower housing to expose the platen.
